(19) United States
(12) Patent Application Publication
(10) Pub. No.: US 2026/0039161 A1
(43) Pub. Date: Feb. 5, 2026

(54) MOTOR

(71) Applicant: MINEBEA MITSUMI INC., Kitasaku-gun, NAGANO (JP)

(72) Inventors: Takayuki YAMASAKI, Kitasaku-gun, NAGANO (JP); Kouji KEBUKAWA, Kitasaku-gun, NAGANO (JP); Kentaro SUZUKI, Kitasaku-gun, NAGANO (JP)

(21) Appl. No.: 19/100,316

(22) PCT Filed: Jun. 2, 2023
(86) PCT No.: PCT/JP2023/020675

§ 371 Date: Jan. 31, 2025

(30) Foreign Application Priority Data
Aug. 3, 2022 (JP) 2022-123908

(51) Int. Cl. H02K 1/2786; H02K 7/08

(52) U.S. Cl. CPC H02K 1/2786; H02K 7/083

(57) ABSTRACT

To improve rigidity during rotation of a rotor in a motor. A motor of the disclosure includes a shaft, a stator, a bearing disposed between the shaft and the stator, and a rotor rotating integrally with the shaft, wherein the rotor includes a magnet and a cover fixed to the shaft and covering the magnet, and the cover includes a protruding part protruding toward the bearing in an axial direction, and an arm part protruding from the protruding part toward the bearing in the axial direction.

### CROSS REFERENCE TO RELATED APPLICATIONS

This application is a national stage entry of International Application no. PCT/JP2023/020675, filed on Jun. 2, 2023, which claims priority to Japanese Patent Application 2022-123908, filed on Aug. 3, 2022, which is incorporated herein by reference.

### TECHNICAL FIELD

The disclosure relates to a motor.

### BACKGROUND

In a known outer rotor type motor having a stator and a rotor, the stator has a bearing holding part, and ball bearings are provided at an upper part and a lower part of the bearing holding part. A shaft of the rotor is attached to a lid part of a yoke of a cup part and is rotatably supported by the ball bearing at the upper part and the ball bearing at the lower part (for example, see JP 2008-175158 A).

### SUMMARY

In the outer rotor type motor having such a configuration, since the lid part as a heavy object is fixed to one side (upper part) of the shaft, when the lid part rotates together with the shaft, a large load is imposed on the shaft and the ball bearing at the upper part, and thus there is a concern that the shaft rigidity during rotation of the rotor may be insufficient.

An example of an object of the disclosure is to improve the shaft rigidity during rotation of a rotor in a motor.

A motor of the disclosure includes a shaft, a stator, a bearing disposed between the shaft and the stator, and a rotor configured to rotate integrally with the shaft, wherein the rotor includes a magnet and a cover fixed to the shaft and covering the magnet, and the cover includes a protruding part protruding toward the bearing in an axial direction and an arm part protruding from the protruding part toward the bearing in the axial direction.

### BRIEF DESCRIPTION OF DRAWINGS

FIG. 1 is a perspective view of a fan including a motor according to an embodiment being one example of the disclosure.

FIG. 2 is a cross-sectional view of the fan including the motor according to an embodiment being one example of the disclosure.

FIG. 3 is a cross-sectional view of the fan including the motor according to an embodiment being one example of the disclosure, and is a cross-sectional view taken along A-A in FIG. 2.

FIG. 4 is a partially enlarged cross-sectional view of the fan including the motor according to an embodiment being one example of the disclosure.

### DESCRIPTION OF EMBODIMENTS

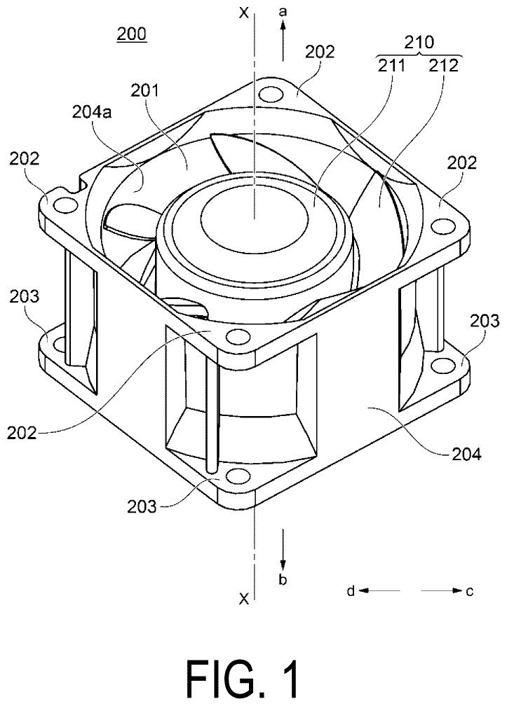

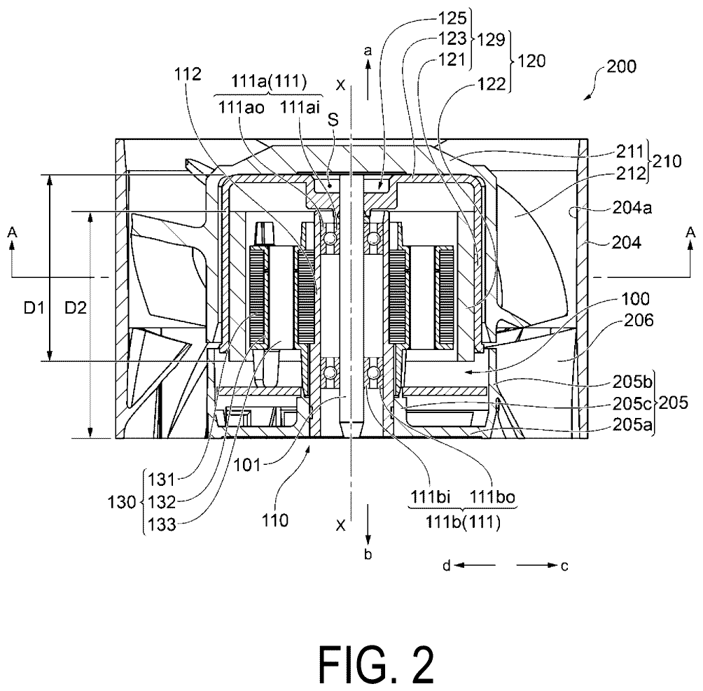

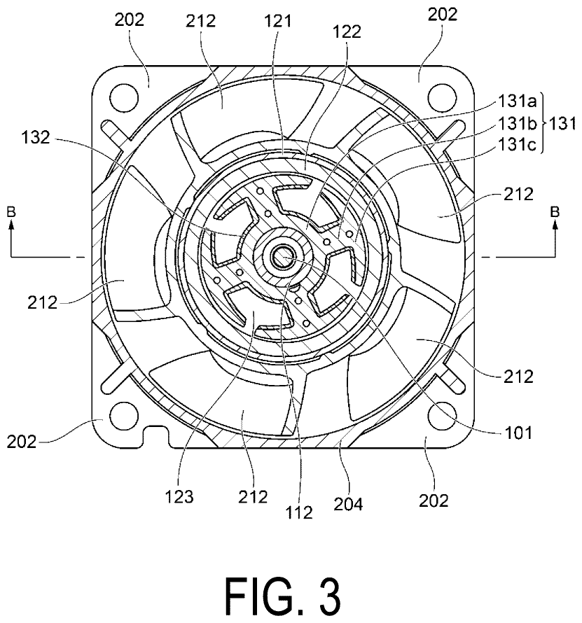

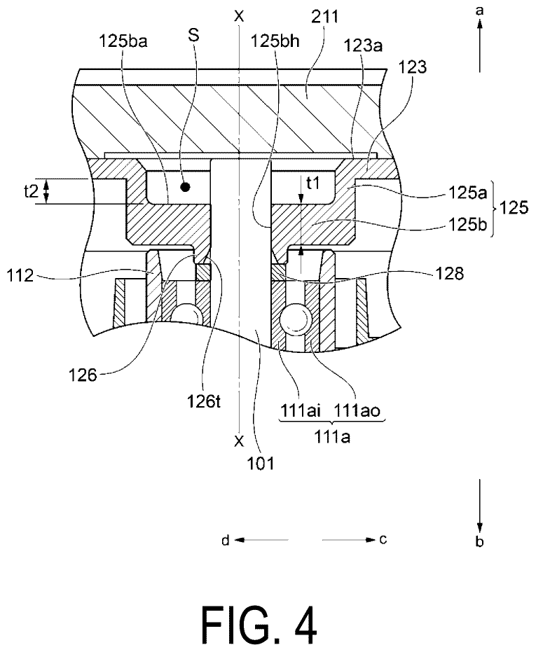

An embodiment being one example of the disclosure will be described below with reference to the drawings. FIG. 1 is a perspective view of a fan 200 according to the present embodiment. FIG. 2 is a cross-sectional view of the fan 200. FIG. 3 is a cross-sectional view of the fan taken along A-A in FIG. 2. FIG. 4 is a partially enlarged cross-sectional view of the fan 200.

In the description of embodiments of the disclosure, for convenience of description, the direction of an arrow a along an X axis is defined to be an upper side or one side in the axial direction. The direction of an arrow b along the X axis is defined as a lower side or the other side in the axial direction. Here, the direction of the arrows a and b is referred to as an up-down direction or an axial direction. However, the up-down direction does not necessarily coincide with a vertical direction. In addition, the direction of arrows c and d is referred to as a radial direction. The direction of the arrow c extending away from the X axis is referred to as an outer side or one side in the radial direction, and the direction of the arrow d extending toward the X axis is referred to as an inner side or the other side in the radial direction.

As illustrated in FIG. 1, the fan 200 according to the present embodiment is a blower sending air from an upper side as one side in the axial direction (direction of the arrow a) toward a lower side as the other side in the axial direction (direction of the arrow b). The fan 200 includes a motor 100 (FIG. 2), to be described below, and an impeller 210 disposed at one side of a shaft 101 of the motor 100 in the axial direction.

The impeller 210 includes a hub 211 and a plurality of blades 212, and is rotationally driven by the motor 100. As illustrated in FIG. 1, the fan 200 has a tubular shape substantially square in plan view and includes an intake opening 201 for sucking air from one side in the axial direction into a wind tunnel part having a hollow cylindrical shape.

The fan 200 includes four flange parts 202 at corners at one side in the axial direction, and four flange parts 203 also at corners at the other side in the axial direction. The four flange parts 202 at one side in the axial direction and the four flange parts 203 at the other side in the axial direction are each provided with a penetrating hole for insertion of a bolt (not illustrated) for attachment to a predetermined apparatus or housing.

As illustrated in FIG. 2 and FIG. 3, the fan 200 includes a side wall 204 having a rectangular shape in plan view and surrounding the impeller 210 from one side in the radial direction, a motor base part 205 formed at an end part at the other side in the axial direction, and a fixed blade 206 formed with a plurality of stationary blades coupling the side wall 204 and the motor base part 205 in the radial direction (direction of the arrows c and d). Note that, instead of the fixed blades 206 coupling the side wall 204 and the motor base part 205, a plurality of spokes formed with rod-like portions may be used.

The side wall 204, the motor base part 205, and the fixed blade 206 of the fan 200 are integrally formed by injection molding of a synthetic resin such as polybutylene terephthalate reinforced with glass fibers, for example. Note that the side wall 204, the motor base part 205, and the fixed blade 206 may be formed of other materials.

The side wall 204 defines a wind tunnel part of the fan 200. The wind tunnel part of the side wall 204 has an inner peripheral surface 204a having a cylindrical shape centered on the X axis. The inner peripheral surface 204a has a diameter to not be in contact with end parts of the blades 212 of the impeller 210 at one side in the radial direction. That is, there is a predetermined gap between the end parts of the blades 212 of the impeller 210 at one side in the radial direction and the inner peripheral surface 204a of the side wall 204.

The side wall 204 also functions as a guard part to protect the impeller 210. At the corners of the side wall 204 at one side in the axial direction, the four flange parts 202 are integrally formed with the side wall 204. Also at the corners of the side wall 204 at the other side in the axial direction, the four flange parts 203 are integrally formed with the side wall 204.

The motor base part 205 is formed of a base part 205a having a substantially disk shape, an outer peripheral wall 205b having a cylindrical shape and extending from an end part of the base part 205a at one side in a radial direction toward one side in the axial direction by a predetermined length, and a boss part 205c having a cylindrical shape and protruding from an end part of the base part 205a at the other side in the radial direction, toward one side in the axial direction by a predetermined length (direction of the arrow d).

On a surface of the outer peripheral wall 205b of the motor base part 205 at one side in the radial direction, the fixed blade 206 is integrally formed. The outer peripheral wall 205b of the motor base part 205 is supported by the side wall 204 of the fan 200 via the fixed blade 206.

The impeller 210 is provided with a hub 211 having a cup shape with a bottom and a cross section substantially in an inverted U-shape and a plurality of blades 212 provided along the circumferential direction at the outer peripheral surface (surface at one side in the radial direction) of the hub 211.

The plurality of blades 212 all have the same shape and are evenly spaced at the gaps in the circumferential direction of the hub 211. The hub 211 and the plurality of blades 212 are integrally formed by injection molding of a synthetic resin such as polybutylene terephthalate reinforced with glass fibers, for example.

The hub 211 of the impeller 210 is fixed to the outer peripheral surface (surface at one side in the radial direction) of a cylindrical part 121 of a rotor 120, to be described below, and a surface of a lid part 123 of the rotor 120 at one side in the axial direction. Note that the cylindrical part 121 of the rotor 120 may be inserted into the hub 211 so that the inner peripheral surface (surface at the other side in the radial direction) of the hub 211 and the outer peripheral surface (surface at one side in the radial direction) of the cylindrical part 121 of the rotor 120 are integrally formed.

The motor 100 includes the shaft 101 and a bearing device 110. The bearing device 110 includes a bearing 111a provided at one side in the axial direction, a bearing 111b provided at the other side in the axial direction, and a holding member 112 holding the bearing 111a and the bearing 111b.

The holding member 112 is made of metal and has a hollow cylindrical shape as a whole. The holding member 112 is press-fitted to an inner peripheral surface (surface at the other side in the radial direction) of the boss part 205c of the motor base part 205. Note that the holding member 112 may be formed integrally with the motor base part 205 in a state of being inserted into the boss part 205c.

In the axial direction, the holding member 112 holds the bearing 111a at one side and holds the bearing 111b at the other side. The bearing 111a and the bearing 111b are ball bearings. Note that the bearing 111a and the bearing 111b are not limited to ball bearings, and various other bearings such as sleeve bearings, for example, may be used. Further, a spring for preload may be provided between the bearing 111a and the bearing 111b.

An outer ring 111ao of the bearing 111a and an outer ring 111bo of the bearing 111b are bonded or press-fitted to the inner peripheral surface (surface at the other side in the radial direction) of the holding member 112. Thus, the outer ring 111ao of the bearing 111a and the outer ring 111bo of the bearing 111b are integrally fixed to the holding member 112.

An inner ring 111ai of the bearing 111a and an inner ring 111bi of the bearing 111b are bonded or press-fitted to the outer peripheral surface of the shaft 101 having a columnar shape. Thus, the inner ring 111ai of the bearing 111a and the inner ring 111bi of the bearing 111b are integrally fixed to the shaft 101.

The bearing 111a rotatably supports one side of the shaft 101 in the axial direction with respect to the holding member 112, and the bearing 111b rotatably supports the other side of the shaft 101 in the axial direction with respect to the holding member 112. Thus, the shaft 101 is supported by the bearing 11 la and the bearing 111b, so as to be rotatable with respect to the holding member 112.

The motor 100 is a single-phase brushless DC motor of an outer rotor type and includes the rotor 120 and a stator 130. Note that the motor 100 is not limited to the single-phase brushless DC motor, and may be motors of other various configurations such as a three-phase brushless DC motor, for example.

The rotor 120 is fixed only to one side of the shaft 101 in the axial direction. The shaft 101 is press-fitted and fixed to an inner peripheral surface of a protruding part 125.

The rotor 120 includes a cover 129. The cover 129 includes the cylindrical part 121 made of a soft magnetic material disposed to be coaxial with the shaft 101, the lid part 123 having a disk shape and extending from the end part of the cylindrical part 121 at one side in the axial direction toward the other side in the radial direction, and the protruding part 125 protruding toward the bearing 111a in the axial direction from a central portion of the lid part 123.

A magnet 122 having a cylindrical shape is integrally fixed to an inner peripheral surface of the cylindrical part 121 to be coaxial with the cylindrical part 121. The cylindrical part 121 functions as a portion to prevent leakage of the magnetic field of the magnet 122.

An end part of the magnet 122 at one side in the axial direction is not in contact with the lid part 123, and the magnet 122 and the lid part 123 are separated from each other by a predetermined distance. An end part of the magnet 122 at the other side in the axial direction slightly protrudes downward from an end part of the cylindrical part 121 at the other side in the axial direction.

As described above, the magnet 122 is disposed so as to protrude downward beyond the cylindrical part 121. This is because when the magnet 122 is disposed farther from the cylindrical part 121 as much as possible at the other side in the axial direction, that is, at the lower side, the center of gravity of the cover 129 is located at the lower side, and the axial load on one side of the shaft 101 in the axial direction during rotation can be reduced.

The cylindrical part 121 and the lid part 123 of the cover 129 are covered by the hub 211 of the impeller 210, and are integrally fixed by an adhesive or the like. The lid part 123 is a portion integrally formed with the cylindrical part 121 while having a function as a lid, and prevents entry of foreign matter. The protruding part 125 will be described below.

The stator 130 is attached to an outer peripheral surface of the holding member 112. However, the stator 130 may be attached directly to the motor base part 205, not via the holding member 112.

The stator 130 includes a stator core 131 formed by a stacked body with a plurality of cores of an electromagnetic steel plate stacked, the electromagnetic steel plate being made of a soft magnetic material, an insulator 132 made of an insulating material mounted at the stator core 131, and a coil 133 wound around the stator core 131 via the insulator 132. The stator core 131 and the coil 133 are insulated by the insulator 132.

As illustrated in FIG. 3, the stator core 131 includes an annular part 131a centered on the X axis, a plurality of (four in this case) tooth parts 131b extending toward one side in the radial direction (direction of the arrow c) from the annular part 131a, and magnetic pole parts 131c formed at end parts at the outer peripheral side of the respective tooth parts 131b. Note that, in FIG. 3, the coil 133 is omitted.

An inner peripheral surface of the annular part 131a of the stator core 131 is fixed to the outer peripheral surface of the holding member 112. Further, the magnetic pole parts 131c of the stator core 131 protrude toward both sides in the circumferential direction, and the distance between the adjacent magnetic pole parts 131c in the circumferential direction is set to be shorter than the distance between the adjacent tooth parts 131b.

When the motor 100 is operated and the rotor 120 is rotated together with the shaft 101 by the electromagnetic action between the rotor 120 and the stator 130, the impeller 210 fixed to the rotor 120 is rotated and air is fed toward the other side in the axial direction by the action of the plurality of blades 212. Therefore, the fan 200 functions as a blower.

As illustrated in FIGS. 2 and 4, in such a configuration, the protruding part 125 formed at the lid part 123 of the cover 129 of the motor 100 is a protruding portion protruding by a predetermined length from the lid part 123 toward the bearing 111a at the other side in the axial direction.

The protruding part 125 includes a cylindrical part (hereinafter referred to as an “axially extending part”) 125a extending by a predetermined length toward the other side in the axial direction, and a disk part (hereinafter referred to as a “radially extending part”) 125b extending by a predetermined length from an end part of the axially extending part 125a at the other side in the axial direction toward the other side in the radial direction.

The axially extending part 125a is a cylindrical portion extending by a predetermined length toward the other side in the axial direction at a central part of the lid part 123, and has an end part at the other side in the axial direction integrally formed with the radially extending part 125b. The axially extending part 125a has a length in the axial direction to not reach the holding member 112.

The radially extending part 125b is a disk-shaped portion extending by a predetermined length from an end part of the axially extending part 125a toward the shaft 101, and has a through hole 125bh, for inserting the shaft 101, formed at the center. The radially extending part 125b has a length (radius) in the radial direction to reach the shaft 101 from an end part of the axially extending part 125a at the other side in the axial direction.

An inner diameter of the through hole 125bh of the radially extending part 125b is the same as an outer diameter of the shaft 101 or slightly smaller than the outer diameter of the shaft 101. The shaft 101 is press-fitted into the through hole 125bh of the radially extending part 125b and integrally fixed using an adhesive.

A thickness t1 of the radially extending part 125b in the axial direction is greater than a thickness t2 of the axially extending part 125a in the axial direction. This is because this structure has the end part of the shaft 101 at one side in the axial direction supported only by the radially extending part 125b of the protruding part 125, and thus requires improvement in the rigidity of the radially extending part 125b supporting the shaft 101. Accordingly, it is possible to increase the shaft rigidity during the integrated rotation of the cover 129 with the shaft 101.

In the protruding part 125, a columnar shaped recessed space S surrounded by the axially extending part 125a and the radially extending part 125b is formed, and an end part of the shaft 101 at one side in the axial direction protruding from the through hole 125bh of the radially direction extending part 125b is exposed in the recessed space S.

The end part of the shaft 101 protrudes from an upper end surface 125ba of the radially extending part 125b of the protruding part 125 toward one side in the axial direction, but does not protrude from an upper end surface 123a of the lid part 123 toward one side in the axial direction. However, as long as the end part of the shaft 101 at one side in the axial direction does not come into contact with the hub 211, the end part may be flush with the upper end surface 123a of the lid part 123 or may protrude slightly from the upper end surface 123a.

In addition, while the end part of the protruding part 125 of the shaft 101 at the one side in the axial direction protrudes from the upper end surface 125ba of the radially extending part 125b, the through hole 125bh and the outer peripheral surface of the shaft 101 are fixed to each other with no gap in between, thereby preventing entry of foreign matter from the outside.

The radially extending part 125b has a cylindrical arm part 126 integrally formed to extend from an end part of the radially extending part 125b at the other side in the radial direction toward the other side in the axial direction, with a length to not reach the bearing 111a. That is, there is a slight gap in the axial direction between end parts of the arm parts 126 at the other side in the axial direction and the bearing 111a, and a washer 128 is attached in the gap.

As illustrated in FIG. 4, a tapered surface 126t is formed at the inner peripheral surface of an opening portion at an end part of the arm part 126 at the other side in the axial direction. Specifically, at the inner peripheral surface of the arm part 126 in contact with the shaft 101, a conical tapered surface 126t is formed to be inclined, so as to be gradually separated from the outer peripheral surface of the shaft 101, from the inner peripheral surface toward the distal end of the opening of the arm part 126. That is, the arm part 126 as a portion protruding from the protruding part 125 has an inclined inner peripheral surface (tapered surface 126t). In the radial direction, an inner diameter of the inclined inner circumferential surface on the bearing-side is larger than an inner diameter of the inclined inner circumferential surface on the end part side (one side in the axial direction) of the shaft 101.

Thus, the end part of the arm part 126 at the other side in the axial direction is separated from the outer peripheral surface of the shaft 101 due to the presence of the tapered surface 126t. Accordingly, the shaft 101 can be easily inserted into the through hole 125bh of the radially extending part 125b from the arm part 126 of the cover 129.

In addition, the washer 128 is interposed in the gap between the end parts of the arm parts 126 at the other side in the axial direction and the bearing 111a, and the arm parts 126 and the bearing 111a are in contact with each other via the washer 128. The arm part 126 may be in direct contact with the bearing 111a without the washers 128 being interposed therebetween.

Since the arm part 126 of the protruding part 125 comes into direct or indirect contact with the bearing 111a, it is possible to restrict the movement of the bearing 111a, held by the holding member 112, toward the one side in the axial direction.

As illustrated in FIG. 2, a length D1 from an end part of the cover 129 at one side in the axial direction, that is, the upper end surface 123a of the lid part 123 (FIG. 4) to an end part of the magnet 122 at the other side in the axial direction is set to be longer than ½ of a length D2 between end parts of the holding member 112 at one side in the axial direction and at the other side in the axial direction. Thus, the relationship D1 >D2/2 holds.

The fact that the relationship of D1>D2/2 thus holds means that the magnet 122 is attached so as to protrude downward from the cylindrical part 121 of the cover 129. With this setting, the center of gravity of the cover 129 is located at the lower side, so that the axial load on the one side of the shaft 101 in the axial direction during the rotation is reduced, and the shaft rigidity can be improved.

According to the above-described configuration, the fan 200 includes the protruding part 125 provided at the lid part 123 of the cover 129, and the shaft 101 is supported by the radially extending part 125b provided at a position close to the bearing 111a of the protruding part 125.

Therefore, in addition to being supported by the bearing 111a and the bearing 111b, the shaft 101 is supported in the vicinity of the shaft 111a by the radially extending part 125b of the protruding part 125 of the cover 129 integrated with the impeller 210 as a heavy object. As a result, the shaft rigidity during rotation of the impeller 210 can be improved as compared with the known technique, and thus the rotation of the impeller 210 can be stabilized.

In addition, the end part of the shaft 101 at one side in the axial direction is exposed in the recessed space S from the through hole 125bh of the radially extending part 125b of the cover 129. and is supported by the radially extending part 125b at a portion more at the lower side than the end part of the shaft 101 at the one side in the axial direction. Therefore, compared with a case where the end part of the shaft 101 at one side in the axial direction is supported by the radially extending part 125b, the shaft rigidity during the integral rotation of the shaft 101 and the cover 129 is improved, whereby stability is improved.

Since in the cover 129, the recessed space S is formed by the axially extending part 125a and the radially extending part 125b of the protruding part 125, the weight of the cover 129 can be reduced as compared with a case where the recessed space S is not formed, and thus the shaft rigidity during the integral rotation of the shaft 101 and the cover 129 can be further improved.

As described above, the motor according to the disclosure has been described with reference to preferred embodiments, but the motor according to the disclosure is not limited to the configuration of the embodiments described above. For example, in the above-described embodiment, the motor 100 is used for the fan 200. However, the motor according to the disclosure may be used in other various apparatuses such as a drone.

In the above-described embodiment, a case is described where the motor 100 is of an outer rotor type. However, the disclosure is not limited to this and the motor 100 may be of an inner rotor type.

In the above-described embodiment, a case is described where the motor 100 has two bearings. However, the disclosure is not limited to this, and the motor 100 may include three or more bearings depending on the length of the shaft 101.

In the above-described embodiment, the motor 100 has the tapered surface 126t formed at the inner peripheral surface of the opening portion at the end part of the arm part 126 at the other side in the axial direction. However, the disclosure is not limited to this, and the end part of the arm part 126 at the other side in the axial direction may be bent away from the outer peripheral surface of the shaft 101.

In addition, the motor according to the disclosure can be appropriately modified and the combinations of the various configurations can be changed by a person skilled in the art according to previously known knowledge. Such modifications are of course included in the scope of the disclosure as long as these modifications still include the configurations of the disclosure.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A motor comprising:
a shaft;
a stator;
a bearing disposed between the shaft and the stator; and
a rotor configured to rotate integrally with the shaft, wherein
the rotor includes a magnet and a cover fixed to the shaft and covering the magnet, and the cover includes:
a protruding part protruding toward the bearing in an axial direction; and
an arm part protruding from the protruding part toward the bearing in the axial direction.

2. The motor according to claim 1, wherein an end part of the shaft is exposed from the protruding part.

3. The motor according to claim 1, wherein
the protruding part includes an axially extending part extending in the axial direction and a radially extending part extending in a radial direction, and
a thickness of the radially extending part in the axial direction is greater than a thickness of the axially extending part in the axial direction.

4. The motor according to claim 1, wherein
a portion protruding from the protruding part includes an inclined inner peripheral surface, and
in a radial direction, an inner diameter of the inclined inner peripheral surface at the bearing side is greater than an inner diameter of the inclined inner peripheral surface at an end part side of the shaft.

5. The motor according to claim 1 further comprising a holding member configured to hold the shaft, wherein
a length from an end part of the cover at one side in the axial direction to an end part of the magnet at the other side in the axial direction is longer than ½ of a length of the holding member in the axial direction.
